(19) United States
(12) Patent Application Publication
(10) Pub. No.: US 2012/0108473 A1
(43) Pub. Date: May 3, 2012

(54) PROCESS FOR TREATMENT OF PRODUCED WATER OBTAINED FROM AN ENHANCED OIL RECOVERY PROCESS USING POLYMERS

(75) Inventors: René PICH, Saint Etienne (FR); Ludwig GIL, Saint Etienne (FR)

(73) Assignee: S.P.C.M. SA, Andrezieux Boutheon (FR)

(21) Appl. No.: 13/282,903

(22) Filed: Oct. 27, 2011

Related U.S. Application Data
(60) Provisional application No. 61/419,094, filed on Dec. 2, 2010.

(30) Foreign Application Priority Data
Nov. 3, 2010 (FR) 1059042

(51) Int. Cl. C02F 9/04; C02F 1/72; C02F 1/76; C02F 1/24; C09K 8/588; C02F 1/70; C02F 1/78; C02F 103/10

(52) U.S. Cl. 507/225; 210/757; 210/703; 210/704

(57) ABSTRACT

A process for treatment of produced water obtained from an enhanced oil recovery process from a reservoir, said water containing at least one water-soluble polymer, wherein:
an oxidising agent is injected into produced water in a quantity such that the viscosity of said water is reduced to a value below 2 cps, advantageously of the order of 1.5 cps, in a short period from the injection of the oxidising agent,
a reducing agent is then injected in the necessary quantity to neutralise all the resulting excess oxidising agent.

Since the first oil crisis, enhanced oil recovery has been studied and applied industrially in limited cases.

One of the processes consists in viscosifying the water injected into the reservoir with polymers so as to enlarge the sweeping area and to increase the oil recovery factor by 10% on average.

Typical polymers are sometimes polysaccharides but more often acrylamide-based polymers (the acrylamide representing, preferably, at least 10 mol %) co-polymerised with any one of acrylic acid, 2-acrylamido-2-methylpropane sulfonic acid or N-vinyl pyrrolidone.

The typical concentration used range from 400 ppm to 8000 ppm.

Some cases use a more complex process, using either a surfactant (Surfactant Polymer (SP) process), or a mixture of alkali/surfactant (Alkali Surfactant Polymer (ASP) process) that emulsifies the oil in place and recovers on average an extra 20% of oil.

The alkalin agents are generally constituted of one or more alkaline agents, for example selected from among hydroxides, carbonates, borates and metaborates of alkali or alkaline-earth metals. Preferably, sodium hydroxide or sodium carbonate will be used. The amounts range from 300 ppm to 30000 ppm.

The surfactants are of many kinds, i.e. anionic, cationic, non-ionic, zwitterionic, and have varied structures, i.e. linear, geminal, branched. They are generally formulated in the presence of solvent and/or co-solvent co-surfactants, and are used at amounts ranging from 300-30000 ppm.

These processes are quite well known today. They can be improved because in many cases, the polymers are not used under conditions where the molecular weight can remain stable over time. The polymers degrade and their molecular weights drop by factors of 4 to 10 with the final molecular weights being 2-5 million. Furthermore, a large fraction of the polymer disappears in the field, either by precipitation (especially at high temperature with brines containing divalent ions such as Ca²⁺ or Mg²⁺), or by adsorption.

After the recovery, regardless of the process, a mixture of oil and “produced” water is obtained, that can usefully be recovered and treated. Different steps are then possible. Firstly, water/oil separation steps are performed, for example in separation tanks, in particular in separators without plates and/or inclined-plate separators. Produced water still contains impurities and must be further purified and treated so that it can be re-injected into the reservoir in the presence of polymer. The next step in treatment consists essentially and sequentially in flotation and/or decantation steps and finally in filtration steps in suitable devices.

The increased recovery yield obtained by the techniques previously cited unfortunately presents an important drawback: physico-chemical change in the produced water that causes difficulties in water treatment.

What happens is that some of the chemicals injected, and among others, the polymer used, remain in the water co-produced with the oil.

At this stage the molecular weight and the anionicity of the polymer have evolved. This causes two problems:
Difficulty in initial separation in the first separation tank and in the inclined-plate separators. This phenomenon is particularly important in ASP where some of the oil is emulsified in a fairly stable way and its coalescence is problematic.
The increased viscosity of the produced water makes it difficult to separate the oil from the suspended materials that it wetted. The separation rate is directly linked to viscosity by Stokes law.

Vs=(2/9)*((Qp−Qf)/η)·g·R²
where Vs: settling velocity
g=gravitational acceleration
η=viscosity
Qₚ=mass density of the suspended particle
Q_{f}=mass density of the fluid
R=radius of the residual particle

Devices for produced water treatment are usually scaled up to operate with viscosities of water to be treated of the order of 1.5-2 cps. With produced water viscosities of 10 cps for example, the resident time required is five times higher and devices required are five times larger.

If this separation is not efficient, the quantities of oil and suspended materials are very high, and require huge filter volumes (for example “Nut-Shell” filters that use walnut shells as a filter medium) that need very frequent washing. Above a certain viscosity, operation becomes impossible.

To return to standard water treatment conditions, several solutions have been proposed:

1) Precipitation of the polymer by trivalent metal salts (aluminium sulfate, aluminium polychloride, ferric chloride, etc.). This method is possible but has five drawbacks:
The reagents acidify the water, and this must be corrected to prevent corrosion,
A colloidal precipitate that is very difficult to treat forms,
A large settler-flocculator and a centrifugation/filtration sludge treatment system have to be used,
The sludge has to be disposed of in a landfill (when this is permitted) or incinerated,
It is very difficult to recover the oil absorbed on the precipitate.

This is a very complex operation, not adapted to field conditions.

2) Precipitation of the polymer by a cationic polymer.

The most suitable polymer is DADMAC (polydiallyldimethylammonium chloride). Compared to the previous case, there is no acidification but:
The precipitate has the consistency of chewing gum and is very difficult to treat,
The oil remains co-precipitated and cannot be recovered.
   3) Precipitation by adsorption, for example, on a calcium bentonite but with quantities of sludge that are higher than in the previous cases.
   4) Ultrafiltration, which although it gives good results in the laboratory has the major drawback of having very low longevity in the field because of irreversible absorptions that can only, in part, be treated by strong acid-base cycles that are difficult to implement in the field.
   5) Many biological degradation tests have failed.

It is known that the viscosity of the polymer can be degraded with limited quantities of oxidising agent, for example with ozone, persulfate, perborate, hypochlorite, hydrogen peroxide, etc. This reaction can be very fast (a few tens of minutes if the temperature is above 40° C.), which is well suited to oil-producing conditions. However, the process is not used for a very simple reason. If we wish to reach sufficient level of polymer degradation in a short period, a high quantity of oxidising agent has to be injected. As a result, a high quantity of free oxidising agent remains and is available to degrade the “new” polymer that is dissolved in this treated water. This will greatly reduce the injection viscosity, and therefore the subsequent oil recovery.

The degradation caused is then such that the addition of polymer stabilizers, such as isopropanol (sacrificial agent), thiourea (free radical scavenger) and water mixture in which the polymer is added, or compositions of stabilizers integrated into the polymer as described in application FR 0953258 before dilution with the injection fluid, are not sufficient to stabilise the viscosity of the polymer solution at a satisfactory level.

Document US 2007/0102359 describes a water treatment process involving membranes. After processing, water that may initially come from enhanced oil recovery can be reused for irrigation or for the production of water supply quality water. This process allows to remove traces of inorganic and organic compounds by flotation, filtration, adsorption, decomposition of optional polymers into carbon dioxide and water. It includes several steps, the first one being aeration of the water to be treated, i.e. exposing the water to oxygen. Simultaneously with the aeration step, water can be sheared. The process described in US 2007/0102359 may also include several additional steps among which oxidation, filtration, adsorption, oxidation, intense filtration, ultra filtration, nano filtration, and ultra filtration. These steps can allow to completely remove polyacrylamide polymers comprised in the injection solution. However, the duration of the oxidation steps and intense oxidation are not specified. In addition, this process does not include a step consisting in adding a reducing agent in order to neutralize any excess oxidant.

The process described in US 2007/0102359 is implemented so as to remove any organic and/or inorganic contaminant. It does not aim at reaching a controlled oxidation of organic polymers.

These conditions would also make the quality of treated water incompatible with its use in oil recovery processes. Indeed, in order to make water compatible with the injection water, it should first be degassed so as to attain an oxygen content of about 20 ppb. This oxygen content corresponds to the injection standards that allow to prevent oxidation of the pipes as well as the degradation of the polymer. In addition, salts (Na⁺, Ca²⁺, Mg²⁺) should also be dissolved in the water in order to make it consistent with the injection water.

Such additional steps would lead to prohibitive costs and therefore to large investments. Furthermore, given the steps involved in this process and the volume of water involved in oil recovery, using this process would certainly not be possible on the equipment that can be found in current oil recovery plants.

The problem that the invention proposes solving is therefore to develop an effective process for treatment of produced water, without having the drawbacks described herein above.

### DESCRIPTION OF THE INVENTION

The purpose of the invention is a process for treatment of water from oil production from reservoirs subject to enhanced oil recovery techniques using a polymer. For instance, it can be implemented on the equipment that can be found in oil recovery plants.

Generally, between 200 and 1000 m³ of water can be injected in a single oil well every day. In addition, an oil field may comprise from 20 (platforms or FPSO (Floating Production, Storage and Offloading) with very high flow rates) to over 10 000 wells. All these fields comprise water treatment equipments (initial separation, inclined plate settlers, flotation nut-shell filters) before reinjection, suitable to the injection conditions found prior to the addition of polymer. Manufacturers in particular limit their warranty to an initial viscosity of 2 cps.

The process according to the invention solves the problems of how to separate water/oil, how to purify the water and its residual oil, and how to reduce suspended solids. Then, the water can be reused to re-solubilise some polymer so as to be re-injected effectively in solution into the reservoir.

The present invention consists in purifying the water co-produced during polymer-based enhanced oil recovery by a treatment sequence. This sequence involves:
firstly, adding an excess, in the produced water, of an oxidising agent of, for example, sodium hypochlorite type, at a concentration that degrades the polymer sufficiently and in a short period in order to reduce its viscosity,
neutralisation of the damaging effect of this necessary excess of oxidising agent by injecting a reducing agent.

The reducing agent thus reverses the redox potential, preventing oxidation and therefore degradation of the polymer intended to be added to this water. In fact, the water treated in this way is then reused to dissolve “new” polymer and provides a solution with stable viscosity intended to be injected into the reservoir in an improved oil recovery process.

In other words, the subject matter of the invention is a process for treatment of produced water obtained from an enhanced oil recovery process from a reservoir, said water containing at least one water-soluble polymer, wherein:
an oxidising agent is injected into produced water in a quantity such that the viscosity of said water is reduced to a value of less than 2 cps, advantageously of about 1.5 cps, in a short period of less than 5 hours from the injection of the oxidising agent,
a reducing agent is then injected in the necessary quantity to neutralise all the resulting excess oxidising agent.

This method aims at not degrading the polymer beyond the viscosity necessary for its proper use in equipment that can be found in oil recovery plants, since a viscosity of 2 cps helps to reduce the amount of extra polymer that is added in the recovery of oil, especially in the case of light oil where the required viscosity is low. Therefore, in general, the duration needed to reach a viscosity of less than 2 cps does not allow the complete oxidation of the polymer. As consequence, the amount of oxidant also depends on the viscosity that has to be reached in the allotted time period. It also depends on the composition of the water and especially on the amount of sulfur impurities (H₂S) that are often found in water production.

As a result, laboratory tests have to be carried out in order to find out the required quantities.

Before treated produced water is re-injected into the reservoir, at least one water-soluble polymer is added to it. In all cases, the excess oxidising agent has been neutralised by the reducing agent before the polymer is added.

The process of treating produced water according to the invention comprises several steps that are successively:
oil/produced water separation steps,
flotation and/or decantation steps,
filtration steps.

In a preferred embodiment, the oxidising agent is added at the start of the water treatment process so that the viscosity decreases as early as possible in the process. In particular, the oxidising agent is added optionally:
during the separation phases,
between the separation and flotation and/or decantation phases,
during the flotation and/or decantation phases.

In the same way, the reducing agent is added at the end of the water treatment process, for example during the filtration phases.

“Short period” is understood to mean resident times that are compatible with the flows of the oil industry i.e. treatment times of less than 10 hours, preferably less than two hours, to limit the size of unit on which this purification sequence is performed. It can usually be comprised between 1 and 5 hours.

The polymer is in practice an acrylamide-based polymer, advantageously co-polymerised with for example acrylic acid, 2-acrylamido-2-methylpropane sulfonic acid or N-vinyl pyrrolidone.

As already stated, the present invention consists in destroying the excess oxidising agent with an effective reducing agent so that the redox potential is reversed.

The process according to the invention can apply to all strong oxidising agents that can cause rapid degradation of the molecular weight of the polymer. For example, the oxidising agent can be a persulfate, a perborate, a hydrogen peroxide, ozone, sodium hypochlorite, sodium chlorite. Generally, the counter-ion for persulfates, perborates, hypochlorites and chlorites can be selected from among the group comprising alkali and alkaline-earth metals.

In a preferred embodiment, sodium hypochlorite produced by electrolysis from produced water or brine is used. These electrolysis devices are manufactured by:
SEVERN TRENT DE NORA (USA)
ELECTROLYTIC TECHNOLOGIES CORPORATION (USA)
DAIKI ATAKA (Japan)

In some cases, a brine enriched with salt from dissolving NaCl can be used, in particular when the salinity of the brine to be injected is insufficient for sodium hypochlorite production.

In practice, the oxidising agent is injected into produced water at 20-500 ppm compared to the weight of the produced water, advantageously from 30-200 ppm.

However, since sodium hypochlorite reacts by oxidising hydrogen sulfide (H₂S), the system using sodium hypochlorite as oxidising agent is limited to fields with low and average H₂S content (less than 250 ppm) to avoid overly high sodium hypochlorite consumption.

Hydrogen sulfide oxidation and destruction is expected in some fields, to reduce equipment corrosion. In this case higher amounts of sodium hypochlorite can be used.

Regarding process control, it is possible to dose the reducing agent precisely by regulating its quantity using an oxidation-reduction probe.

The reducing agent is added before the polymer to be injected is dissolved, preferably 2 hours before, more preferably 1 hour before, so that the reducing agent has the time to react with the excess oxidising agent.

Reducing agents that can be used are, as non-exhaustive examples, compounds such as sulfites, bisulfites, metabisulfites (and in particular metabisulfite, dithionites of alkali or alkaline-earth metals). It can also be hydrazine and its hydroxylamine derivatives or even a mixture of sodium borohydride and bisulfite. Their use for polyacrylamides is described in U.S. Pat. No. 3,343,601. All these act as reducing agent, modifying the redox potential of the aqueous solution in which they are added. Using a reducing agent selected from among organic sulfites such as alkyl sulfites, alkyl hydrosulfites, sulfinates, sulfoxylates, phosphites, and also oxalic or formic acid or salts of erythorbate and carbohydrazides, can also be considered.

According to the invention, the reducing agent is injected at 10-300 ppm compared to the weight of produced water, advantageously from 15-200 ppm.

Under usual field conditions where the brine temperature is greater than 40° C., this reaction is very fast.

A further object of the invention is an improved enhanced oil recovery process consisting in injecting into the reservoir a solution of water and at least one water-soluble polymer whereby the water used is produced water treated according to the previously described process.

In the usual injection method, just before said injection a reducing agent for oxygen is added to remove the problems linked to oxygen coming from dissolution equipment and to prevent corrosion in the injection systems.

However, the quantity added:
is low compared to the quantity needed to reduce the excess oxidising agent. It is in a high excess compared to the oxygen present (20-100 ppb) and is standardised at 5 ppm,
and is added after the polymer is dissolved.

In the process of the invention, the reducing agent neutralizing at least part of the oxidising agents, is added before the polymer is dissolved so as to prevent its fast degradation and the oxygen scavenger (reducing agent for oxygen) is maintained at injection to remove oxygen coming, in particular, from the polymer dissolution material (powder feeder, dispersion, maturation tanks), that at low levels causes corrosion and optionally slow polymer degradation.

The oxygen scavenger can be selected from among the group of reducing agents of oxidising agent mentioned previously.

The invention and the advantages that flow from it are clear from the following embodiment examples that lean on the appended FIGURE.

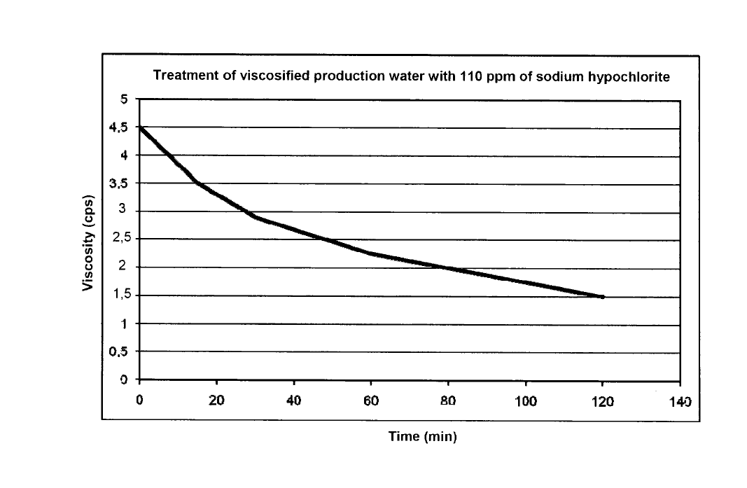

FIG. 1 is a graphic representation of the viscosity of produced water after adding oxidising agent according to example 1.

### EXAMPLE 1

### Comparative Example

An aqueous solution of polymer is prepared from 1000 ppm of polyacrylamide having molecular weight 20 million g/mol, 30% hydrolysed, that is dissolved in water with the following composition:

| | | |
|---|---|---|
| Na⁺ | 947 | mg/L |
| Cl⁻ | 1462 | mg/L |
| H₂S | 20 | ppm |
| Temperature | 44° | C. |

This polymer solution is injected into a reservoir. The viscosity of the oil is 10 cps; the viscosity of the polymer solution injected is 40 cps. The viscosity of the produced water is 4.5 cps with 300 ppm polymer. At this viscosity, the standard production materials do not function in the medium term. In fact, the flotation device is not very effective and produces fluid water containing 250 ppm oil and 40 ppm suspended materials, which quickly saturate nut-shell filters.

The oxidation treatment will give the following results:

Using an electrolysis device using produced water as brine, a quantity of 110 ppm sodium hypochlorite is generated.

In 15 minutes, the viscosity of the solution drops to 3.5 cps.

As FIG. 1 shows, after 30 minutes, the viscosity of the solution drops to 2.9 cps. At 60 minutes it drops to 2.25 cps. At 120 minutes it drops to 1.5 cps, which allows a standard, effective water treatment to be performed.

In the field, at the inclined-plate settler an amount of 110 ppm of sodium hypochlorite is applied.

At the flotation unit outlet, the viscosity is below 2 cps (1.4 cps to 1.7 cps) and the nut-shell filters then show adequate washing periods.

This water treated then purified for residual oil and its suspended solids is used to dissolve polymer again before re-injection. A first dissolution is done at 10 g/L then an in-line dilution at 1000 ppm is performed.

A sample of this solution is aged under controlled conditions for 24 hours. Whereas with water untreated by hypochlorite, the viscosity is 40 cps, the solution in the treated and purified water is only 14 cps, which is a degradation of more than 60%.

This degradation increases with the molecular weight of the polymer, which initially reduces the viscosity of the polymer solution sweeping the reservoir very quickly, and therefore reduces its ability to recover oil. Secondly, since the hypochlorite reacts by oxidation on the H₂S, the system is limited to fields with low and medium H₂₅ content (less than 250 ppm) to avoid overly high sodium hypochlorite consumption.

### EXAMPLE 2

### Example 1 According to the Invention

Under the same conditions as example 1, the sodium hypochlorite treatment (110 ppm) is performed at the inclined-plate settler, then 25 ppm of sodium hydrosulfite is added at the nut-shell filters and the polymer is dissolved under standard conditions. The viscosity of a solution sample injected after 24 hours ageing is then stable at 40 cps, i.e. without degradation compared to a standard treatment. In the tests performed, the quantity of oil has little influence on hypochlorite consumption.

### EXAMPLE 3

### Example 2 According to the Invention

In this case, a well is treated with an ASP system with the same brine but softened, i.e. the calcium and magnesium ions are substituted by sodium.

The quantities of reagents added are as follows:

| | |
|---|---|
| Polyacrylamide | 2000 ppm |
| (20 million, 30% hydrolysis) | |
| Surfactant | 4000 ppm |
| Sodium carbonate | 5000 ppm. |

The injection viscosity is 45 cps.

The produced water has the following characteristics:
Viscosity of the produced water: 5.3 cps
pH of the produced water: 8.5
Residual polyacrylamide
   650 ppm
   Molecular weight 3.5 million
Residual surfactant:
   800 ppm.

From laboratory tests, we determine that to this produced water, 150 ppm of sodium hypochlorite must be added to reduce viscosity to less than 2 cps in 2 hours and that at this moment 40 ppm sodium hydrosulfite must be added to destroy the residual sodium hypochlorite.

This treatment is applied as previously described. After 24 hours ageing, the viscosity is maintained at 45 cps.

1. A process for treatment of produced water obtained from an enhanced oil recovery process from a reservoir, said water containing at least one water soluble polymer, wherein:
an oxidising agent is injected into produced water in a quantity such that the viscosity of said water is reduced to a value below 2 cps in a short period of less than 5 hours from the injection of the oxidising agent, and
a reducing agent is then injected in the necessary quantity to neutralise all the resulting excess oxidising agent.

2. The process according to claim 1, wherein the viscosity of said water is reduced to a value between 1.4 and 1.7 cps.

3. The process according to claim 1, wherein the time period is less than 2 hours.

4. The process according to claim 1, wherein the polymer is acrylamide-based.

5. The process according to claim 4, wherein the polymer is co-polymerised with acrylic acid, 2-acrylamido-2-methylpropane sulfonic acid or N-vinyl pyrrolidone.

6. The process according to claim 1, wherein the oxidising agent is selected from the group consisting of persulfate, perborate, hydrogen peroxide, ozone, sodium hypochlorite, and sodium chlorite.

7. The process according to claim 6, wherein sodium hypochlorite is the oxidising agent and is produced by electrolysis from brine or produced water.

8. The process according to claim 1, wherein the oxidising agent is injected at 20-500 ppm.

9. The process according to claim 8, wherein the oxidising agent is injected at 30-200 ppm.

10. The process according to claim 1, wherein the reducing agent is selected from the group consisting of sulfites, bisulfites, metabisulfites, hydrazine and its hydroxylamine derivatives, a mixture of sodium borohydride and bisulfite, alkyl sulfites, alkyl hydrosulfites, sulfinates, sulfoxylates, phosphites, oxalic acid, formic acid, erythorbate salts, and carbohydrazides.

11. The process according to claim 1, wherein the reducing agent is injected at 10-300 ppm.

12. The process according to claim 11, wherein the reducing agent is injected at 15-200 ppm.

13. The process according to claim 1, wherein said process comprises several steps that are successively:
oil/produced water separations,
flotation and/or decantation,
filtration.

14. The process according to claim 13, wherein the oxidising agent is added in any of these ways:
during the separation steps,
between the separation and flotation and/or decantation steps,
during the flotation and/or decantation steps.

15. The process according to claim 13, wherein the reducing agent is added during the filtration steps.

16. The process according to claim 1, wherein the hydrogen sulfide content of the field is less than 250 ppm.

17. An improved enhanced oil recovery process comprising injecting into a reservoir a solution of water and water-soluble polymer wherein the water used is produced water treated according to the process according to the process in claim 1.

18. An improved enhanced oil recovery process comprising injecting into a reservoir a solution of water and water-soluble polymer wherein the water used is produced water treated according to the process according to the process in claim 5.

19. An improved enhanced oil recovery process comprising injecting into a reservoir a solution of water and water-soluble polymer wherein the water used is produced water treated according to the process according to the process in claim 11.

20. An improved enhanced oil recovery process comprising injecting into a reservoir a solution of water and water-soluble polymer wherein the water used is produced water treated according to the process according to the process in claim 6.
